(19) United States
(12) Patent Application Publication
(10) Pub. No.: US 2013/0220040 A1
(43) Pub. Date: Aug. 29, 2013

(54) VIBRATION-FREE OPPOSED PISTON ENGINE

(71) Applicant: FRANZ J. LAIMBOECK, GOLETA, CA (US)

(72) Inventor: FRANZ J. LAIMBOECK, GOLETA, CA (US)

(73) Assignee: MAHLE KOENIG KOMMANDITGESELLSCHAFT GMBH & CO KG, Rankweil (AT)

(21) Appl. No.: 13/604,819

(22) Filed: Sep. 6, 2012

Related U.S. Application Data
(60) Provisional application No. 61/531,369, filed on Sep. 6, 2011.

(51) Int. Cl. F16H 21/22

(52) U.S. Cl. CPC F16H 21/22
USPC 74/44

(57) ABSTRACT

An engine has a cylinder, in which two pistons are mounted which are driven in opposite directions. Each piston drives, via a crankshaft, a toothed disk which is attached on the crankshaft. The two toothed disks are coupled to one another with regard to their rotational movement, or the toothed disks that are attached to the two crankshafts are in meshing engagement with one another. The crankshafts are driven by the pistons to produce a rotational movement in opposite directions. The toothed disks have the same diameter and are in direct engagement with one another by way of teeth which are arranged or formed along their circumference.

### CROSS-REFERENCE TO RELATED APPLICATION

This application claims the benefit, under 35 U.S.C. §119(e), of provisional patent application No. 61/531,369 filed Sep. 6, 2011; the prior application is herewith incorporated by reference in its entirety.

### BACKGROUND OF THE INVENTION

### Field of the Invention

The invention relates to an engine with a cylinder, in which two pistons are mounted that are driven in opposite directions. Each piston drives, via a crankshaft, a toothed disk which is attached on the crankshaft, and the two toothed disks being coupled to one another with regard to their rotational movement, or the toothed disks which are attached to the two crankshafts being in engagement with one another and the crankshafts being driven by the pistons to produce a rotational movement in opposite directions.

Engines of this type will be explained in greater detail in the following text using FIG. 1. The engine which is shown in FIG. 1 comprises a cylinder 35, in which two pistons 3, 4 are mounted which are connected via piston rods 5, 6 and via connecting rods 36, 37 to in each case one crankshaft 7, 8. If ignition takes place of the combustible fluid which is fed via inflow ducts 31 into the cylinder chamber, the two pistons 3, 4 are pressed apart from one another simultaneously and the crankshafts 7, 8 are therefore rotated. The exhaust gases are discharged via an exhaust gas line 32. Toothed disks 16, 17 are attached to the crankshafts 7 and 8, which toothed disks 16, 17 are driven via a toothed belt 18 to produce a rotational movement in the same direction. Apart from vibrations, undesirable alternating torques and gyro effects also occur in the event of positional change in an engine of this type, on account of the toothed disks which rotate in the same direction, and synchronization defects such as high torque peaks in the event of an unequal power consumption at the toothed disks. It is also possible that the toothed disks 16, 17 which are attached to the two crankshafts 7, 8 are in engagement with one another and the crankshafts 7, 8 are driven by the pistons 3, 4 to produce a rotational movement in opposite directions.

### SUMMARY OF THE INVENTION

It is an aim of the invention to produce an engine which is of simple construction and is as free as possible of vibrations.

According to the invention, an engine having a cylinder, in which two pistons are mounted which are driven in opposite directions, each piston driving, via an articulation connecting shaft and a crankshaft, a toothed disk, which is attached on the crankshaft, and the two toothed disks being coupled to one another with regard to their rotational movement, or the toothed disks which are attached to the two crankshafts being in engagement with one another and the crankshafts being driven by the pistons to produce a rotational movement in opposite directions, is characterized in that the toothed disks have the same diameter and are in direct engagement with one another by way of teeth which are arranged or formed along their circumference.

The movements of the two toothed disks which are seated in each case on one of the crankshafts are coupled to one another and the toothed disks are rotated in opposite directions. As a result of the movements in opposite directions, no free inertial forces or moments or alternating torques with respect to the surroundings occur. Since the two toothed disks rotate in opposite directions and have the same centrifugal mass (GD²), the gyroscopic (gyro) forces which are brought about by the rotating masses cancel one another out.

The construction of an engine of this type is particularly simple, in particular, when the two toothed disks are configured identically.

As a result of the engagement of the two toothed disks which takes place directly and/or via a toothed belt, a play between the toothed disks is largely avoided, as a result of which a considerable advantage over the prior art is achieved, in which the toothed disks are coupled via a toothed belt which surrounds the two toothed disks or by way of gearwheels which are connected in between. In known couplings of this type, undesirable inhomogeneities in the synchronization of the two pistons are produced by the elements which are connected in between, that is to say by the circulating toothed belt and the gearwheels which are connected in between, with the result that the aim according to the invention is not achieved, namely to produce a low-vibration and low-noise engine.

It can be provided that the toothed disks have the same diameter and are in engagement with one another directly by way of the teeth which are arranged along their circumference, or that a toothed belt is supported by one toothed disk, which toothed belt wraps around said toothed disk, is provided on its inner side with teeth which engage into the recesses of said toothed disk, and bears teeth on its outer side, which teeth engage into the depressions between the teeth of the toothed disk which is supported by the other crankshaft. It is possible here that the toothed belt is placed optionally onto one of the two disks. Both possible embodiments result in direct engagement of the two toothed disks, whereby the smooth running of the engine is optimized. The overall length of the engine is small because the crankshaft axial spacing can be reduced by a reduction in the overall height of the individual crank mechanisms.

The operating principle of the engine can be selected as desired; engines of this type are suitable as 2-stroke, 4-stroke, 6-stroke engine, etc. and can be operated as a naturally aspirated engine or a supercharged engine. The engines can have spark ignition or compression ignition; alternative combustion concepts can also be used. Direct injection, semidirect injection, crankcase injection, intake manifold injection or the arrangement of a carburetor can be provided. Finally, the engine could also be operated as a steam engine with steam injector or steam control valve.

The freedom from vibrations of the engine and the small overall height are particularly advantageous.

An operationally reliable and simple construction results if the toothed belt is of symmetrical construction with regard to its longitudinal plane which extends between the teeth which project from the surfaces which lie opposite one another, and/or if the teeth along the toothed belt which project from the faces of the toothed belt which lie opposite one another are at in each case identical spacings.

The overall length of the engine is small and the operating behavior is improved if the bore of the cylinder is larger than the stroke of the crank mechanism, the ratio of stroke to bore possibly being 0.4≦V≦0.6, and/or if the connecting rod ratio SV of the engine, that is to say the ratio of crank radius to the connecting rod length, is 0.25≦SV≦0.35.

It is particularly advantageous if at least one of the toothed disks is configured as a rotor of a current generator, and/or if the toothed disks bear pole shoes made from magnetic material or plates or rods which conduct magnetic flux, and/or if the toothed disks have a toothed rim or the vanes of a turbomachine, for example an axial fan, lie or are formed in the space which is surrounded by the toothed rim or in recesses in the toothed disk, and/or if the toothed disks have recesses or apertures in their disk face, and/or if the toothed rim of the toothed disks is supported by spokes or carriers which project radially from the shaft bearing of the toothed disk.

These embodiments of engines exhibit a compact construction and a high degree of efficiency in addition to low-noise and low-vibration operation.

Other features which are considered as characteristic for the invention are set forth in the appended claims.

Although the invention is illustrated and described herein as embodied in a vibration-free opposed piston engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1, which was described above, is an elevation view of a two-piston engine;

FIG. 2 shows a diagrammatic view of an engine according to the invention.

FIG. 3 shows a detailed view of toothed disks which are in engagement with one another.

FIGS. 4 and 5 diagrammatically show sectional views of one embodiment of an opposed piston engine according to the invention.

### DETAILED DESCRIPTION OF THE INVENTION

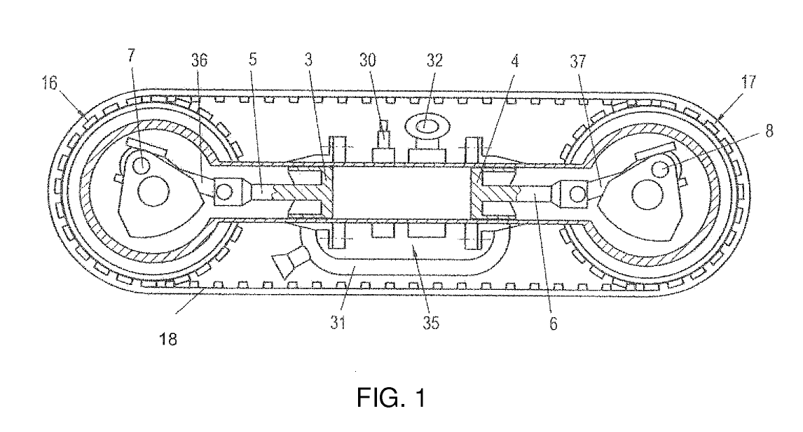

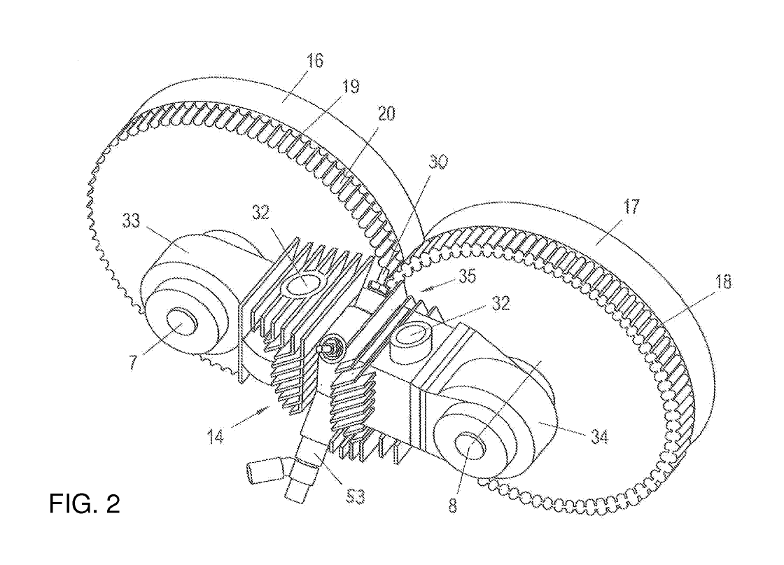

FIG. 2 shows an engine which has a cylinder 35 of short configuration and in which, as shown in FIG. 1, two pistons 3, 4 are arranged and are driven in opposite directions. Crankcases 33, 34 are connected to the housing of the cylinder 35, in which crankcases 33, 34 crankshafts 7 and 8 are mounted. Each crankshaft 7, 8 supports a toothed disk 16 and 17, respectively. The toothed disks 16, 17 have depressions 20, between which the teeth 19 are formed. Said toothed disks 16, 17 can mesh directly with one another or engage into one another, or it can be provided as an alternative that a toothed belt 18 is supported by one toothed disk 17, which toothed belt 18 wraps around said toothed disk 17, is provided on its inner side with teeth 22 which engage into the recesses 20 of said toothed disk 17, and bears teeth 21 on its outer side, which teeth 21 engage into the depressions 20 between the teeth 19 of the toothed disk 16 which is supported by the other crankshaft 8. It is expediently provided that at least one of the toothed disks 16, 17 is configured as a rotor of a current generator. In FIG. 2, 30 denotes an ignition unit and 53 denotes an injection unit.

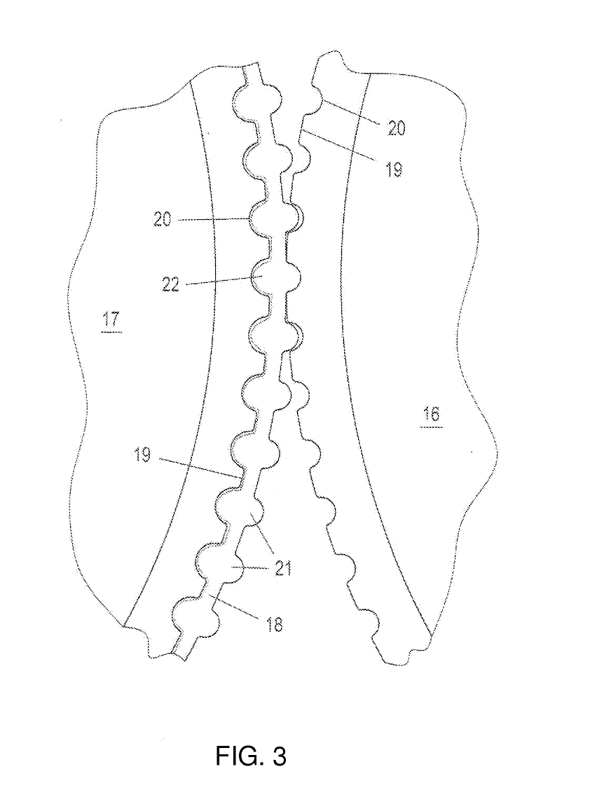

FIG. 3 shows the coupling or the direct engagement of the toothed disks 16, 17 in detail. It can be seen that the teeth 21, 22 of the toothed belt 18 engage into the recesses 20 of the toothed disks 16, 17. This firstly achieves coupling of the toothed disks 16, 17 which is damped on account of the material of the toothed belt 18, which contributes to the suppression of noise and vibrations. A toothed belt of this type is composed of elastic, optionally fiber-reinforced, plastic material and brings about both noise damping and drive jolt damping on account of its elasticity. Noise which is caused by the metallic gearwheels coming into contact with one another is damped by the belt. The toothed belt 18 is seated in a fixed or tensioned manner on the toothed disk 17.

It is favorable for the operating condition if the connecting rod ratio SV of the engine, that is to say the ratio of crank radius R to the connecting rod length L, is 0.25≦SV≦0.35. The toothed disks 16, 17 can have a toothed rim 50, and the vanes of a turbomachine, for example an axial fan, can be arranged in the space which is surrounded by the toothed rim 50 or in a recess.

At least one of the toothed disks 16, 17 can be configured as a rotor of a current generator. It can be provided here that the toothed disks 16, 17 bear pole shoes made from magnetic material or plates or rods which conduct magnetic flux.

As a result of the engagement of the toothed disks 16, 17 into one another, the movements of the pistons 3, 4 are synchronized. However, it is also possible to arrange or to set the toothed disks 16, 17 on the two crankshafts 7, 8 such that they are offset angularly with respect to one another, with the result that the pistons 3, 4 no longer operate synchronously, but rather in a phase-shifted manner. This phase adjustment can sometimes be advantageous for the operation of the engine. If the toothed disks 16, 17 are attached mechanically on the crankshafts 7, 8 in such a way that the pistons are situated in a defined different stroke position, for example by being screwed fixedly in different angular positions of the crankshafts, a fixed phase shift of the piston movements can be achieved in this way. However, it is also possible to couple a toothed disk to its crankshaft via a differential, with the result that a continuous phase shift of the work strokes of the two pistons which operate in opposite directions can be achieved by an adjustment of the differential.

The configuration of the toothed disks 16, 17 in order to accept the power of the engine can be effected in any desired manner. The toothed disks 16, 17 can be used as part of an electric generator or as part of a gear mechanism. The equipment which is driven by the two toothed wheels profits from the vibration-free and synchronously proceeding movement of the two toothed disks.

The two toothed disks 16, 17 can advantageously be configured as rotors of a generator and can bear pole shoes made from permanently magnetic material, for example from rare earth metals such as neodymium, cobalt or samarium. Said pole shoes can be inserted or cast into the toothed disks. In particular if they act as a rotor, the toothed wheels 16, 17 can be formed from lightweight metal or from fiber-reinforced plastic. Plastoferrite strips can be inserted into the rotors, which plastoferrite strips are plastic tapes which are produced by injection molding and into which small iron particles are molded which are magnetized after the introduction or arrangement of the strips in the rotor. Furthermore, there is also the possibility to produce the generators as short circuit rotors of an asynchronous motor, in which the plates or rods which conduct flux are cast into the rotor.

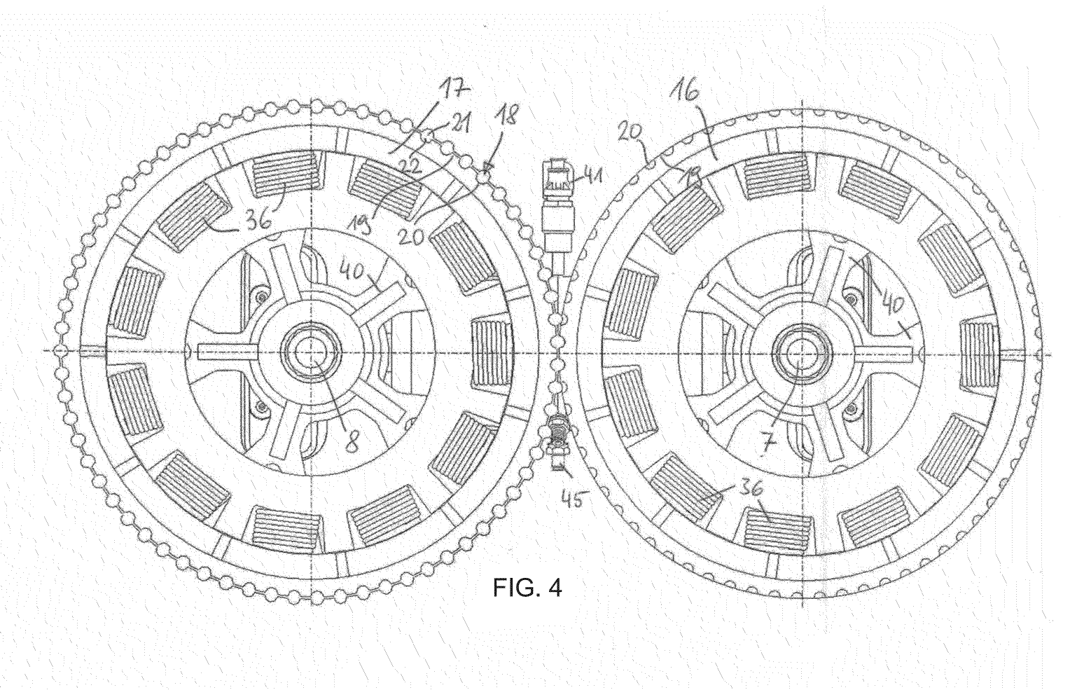

FIG. 4 shows a sectional view of an opposed piston engine according to the invention, perpendicularly with respect to the rotational axis of the toothed disks 16, 17. The toothed belt 18 has teeth which are of approximately circular configuration in cross section and project on both sides of the belt surface in the form of half cylinders. Said projections or teeth 21, 22 are received in corresponding half-cylindrical depressions or recesses 20 of the two toothed disks 16, 17. Elliptical or trapezoidally shaped teeth are also possible.

The two toothed disks 16, 17 can be mounted or supported on the respective crankshaft 7, 8 by means of spokes 40, in order to reduce the weight of the engine. Furthermore, the ignition unit 45 which lies in the center region of the engine and an injection unit 41 for fuel can be seen in FIG. 4.

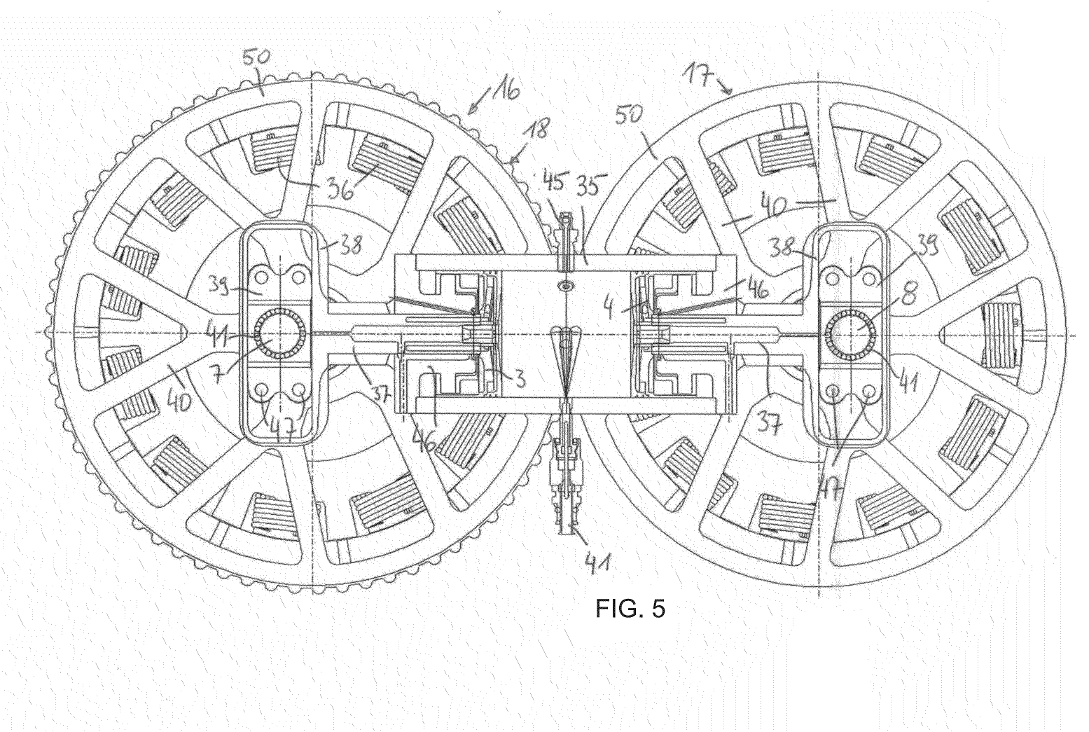

FIG. 5 shows a diagrammatic section through an opposed piston engine according to the invention. The connecting rods 37 of the two pistons 3, 4 are mounted in each case in a guide 46 which closes the two ends of the cylinder 35. In this embodiment, the connecting rods 37 are connected rigidly to the respective piston 3, 4. In the end region which is remote from the cylinder, the connecting rods 37 in each case bear a radial bearing 38, in which a sliding block 39 is mounted such that it can move to and fro on rollers 47. The sliding block comprises a bearing 41, in which the crankshaft 7, 8 which is driven in each case by the piston 3, 4 via the connecting rod 37 is received.

The advantage of the arrangement of large toothed disks as rotors consists in the fact that, in the case of large diameters, the power output of the electric machine is improved, since the power output is dependent on the speed at which the magnets or the conductors run past the coils. A step-up transmission of the angular speed of the crankshafts 7, 8 toward higher angular speeds is therefore not required in the engine according to the invention.

It is advantageous that the engine according to the invention can be started via the toothed disks if the electric machine or the generator is supplied with current by a battery, for example, or is set in motion for the engine start.

Furthermore, it can be provided that the crank mechanism is of offset configuration in order to reduce the piston lateral force. In order to improve the kinematics and to reduce the bending moment in the region of the connecting rod bearing, the cylinder can be arranged in an offset manner, that is to say the cylinder center line lies in front of the crankshaft center line in the rotating direction by from approximately 4 to 10% of the cylinder bore.

According to FIG. 2, the toothed belt 18 has teeth 21, 22 which are configured identically on both sides. According to FIG. 3, the teeth 22 which face the toothed disk 17 are configured to be larger than the teeth 21 which face the toothed disk 16. A toothed belt 18 of this type can also optionally be placed onto both toothed disks 16, 17 if it is turned correspondingly.

In the simplest case, the toothed disks 16, 17 are spur gears with teeth which are arranged along the circumference. The toothed disks 16, 17 rotate in a plane which extends perpendicularly with respect to the crankshafts 7, 8.

It has been shown that it is of significance for an engine according to the invention that almost complete mass balancing is ensured. Furthermore, it is of significance to synchronize the rotation of the two crankshafts 7, 8 and to load to as little an extent as possible the toothed disks 16, 17 which are in engagement with one another. It is therefore possible to perform the synchronization between the toothed disks 16, 17 by means of a toothed belt 18. It is also of significance here, however, that the power consumption is comparable or equal at the two crankshafts 7, 8 because, as a result, the forces which act on the toothed belt 18 are kept low and excessive wear of the toothed belt 18 can be avoided and the latter can be of more diminutive and therefore low-loss design.

As can be seen, in particular, from FIG. 2, it is provided that the end regions of the housing of the cylinder 35 are connected in each case to a crankcase 33, 34, in which a crankshaft 7, 8 is mounted in each case which is connected to the respective piston 3, 4 via an articulation connecting rod 36 or a straight connecting rod with sliding crank 38. This requires that the bearing or rotational axis 7′, 8′ of the two crankshafts 7, 8 in each case intersects the longitudinal axis of the cylinder 35 perpendicularly. A symmetrical construction of the engine, comprising the pistons 3, 4, the connecting rods 36, 37, the cylinder 35 and the toothed disks 16, 17, is therefore also achieved with regard to a plane which is defined by the bearing or rotational axes 7′, 8′ of the two crankshafts 7, 8. At the same time, the engagement region of the gearwheels extends in a close region on both sides of the plane which is defined by the bearing or rotational axes 7′, 8′ of the two crankshafts 7, 8.

Operation of the engine which prevents damage to the toothed belt results if a power load, for example a current generator, is connected to each of the toothed disks 16, 17, the two power loads having or carrying out an identical or very similar or comparable power consumption or being of structurally identical configuration.

The connection of the respective piston 3, 4 to its crankshaft 7, 8 takes place via an articulation connecting rod 36, 37 (FIG. 1) or a straight connecting rod 37 and a sliding crank 38 (FIG. 5).

1. An engine, comprising:
a cylinder, two pistons mounted in said cylinder and driven in opposite directions;
each piston driving, via a respective crankshaft, a toothed disk attached to said crankshaft;
said two toothed disks being coupled to one another with regard to a rotational movement thereof, or said toothed disks that are attached to said two crankshafts being in engagement with one another and said crankshafts being driven by said pistons to produce a rotational movement in mutually opposite directions;
said toothed disks having the same diameter and being in direct engagement with one another by way of teeth which are arranged or formed along their circumference.

2. The engine as claimed in claim 1, wherein the end regions of the housing of the cylinder are connected in each case to a crankcase, in which a crankshaft is mounted in each case which is connected to the respective piston via an articulation connecting rod or a straight connecting rod with sliding crank.

3. The engine as claimed in claim 1, wherein the two toothed disks are configured identically or with the same diameter.

4. The engine as claimed in claim 1, wherein a toothed belt is supported by one toothed disk, which toothed belt wraps around said toothed disk, is provided on its inner side with teeth which engage into the recesses of said toothed disk, and bears teeth on its outer side, which teeth engage into the depressions between the teeth of the toothed disk which is supported by the other crankshaft.

5. The engine as claimed in claim 1, wherein the toothed belt is of symmetrical construction with regard to its longitudinal plane which extends between the teeth which project from the surfaces which lie opposite one another, and/or in that the teeth along the toothed belt which project from the faces of the toothed belt (18) which lie opposite one another are at in each case identical spacings.

6. The engine as claimed in claim 1, wherein at least one of the toothed disks is configured as a rotor of a current generator.

7. The engine as claimed in claim 1, wherein the toothed disks bear pole shoes made from magnetic material or plates or rods which conduct magnetic flux.

8. The engine as claimed in claim 1, wherein the bore of the cylinder is larger than the stroke of the crank mechanism, the ratio (V) of stroke (H) to bore (B) possibly being 0.4≦V≦0.6.

9. The engine as claimed in claim 1, wherein the connecting rod ratio (SV) of the engine, that is to say the ratio of crank radius (R) to the connecting rod length (L), is 0.25≦SV≦0.35.

10. The engine as claimed in claim 1, wherein at least one toothed disk has a toothed rim, the vanes of a turbomachine, for example an axial fan, being formed in the interior space which is surrounded by the toothed rim.

11. The engine as claimed in claim 1, wherein the toothed disks have recesses or apertures in their disk face, and/or in that the toothed rim of the toothed disks is supported by spokes or carriers which project radially from the shaft bearing of the toothed disk.

12. The engine as claimed in claim 1, wherein the crank mechanism is of offset configuration in order to reduce the piston lateral force.

13. The engine as claimed in claim 1, wherein the crank mechanism is arranged in an off-center manner in order to reduce tilting of the piston with regard to the gudgeon pin.

14. The engine as claimed in claim 1, wherein the toothed disks are configured such that they can be placed and fixed in selectable angular positions on the crankshaft which supports them.

15. The engine as claimed in claim 14, wherein at least one of the toothed disks is mounted such that its angle can be adjusted with regard to the crankshaft which supports it, in order to set a predetermined phase shift of the coupled movement of the two pistons.

16. The engine as claimed in claim 1, wherein the bearing or rotational axis of the two crankshafts in each case intersects the longitudinal axis of the cylinder perpendicularly.

17. The engine as claimed in claim 1, wherein the engagement region of the toothed disks extends in a close region on both sides of a plane which is defined by the bearing or rotational axes of the two crankshafts.

18. The engine as claimed in claim 1, wherein, in order to balance the alternating mass torques, the crankshafts are of identical configuration and identical centrifugal masses are provided.

19. The engine as claimed in claim 1, wherein a power load, for example a current generator, is connected to each of the toothed disks, the two power loads having or carrying out an identical or very similar or comparable power consumption and/or being of structurally identical configuration.

20. The engine as claimed in claim 1, wherein the rotor of a current generator is provided as power load and/or the two toothed disks are configured in each case as a rotor of a current generator, the current generators having identical or comparable power consumption.
